(19) United States
(12) Patent Application Publication
(10) Pub. No.: US 2008/0266401 A1
(43) Pub. Date: Oct. 30, 2008

(54) Electronic device with variably positionable imaging device

(76) Inventors: Walter G. Fry, Houston, TX (US); Jeffrey A. Lev, Cypress, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/789,671

(22) Filed: Apr. 24, 2007

(51) Int. Cl. H04N 5/225

(52) U.S. Cl. 348/207.1; 348/E07.079

(57) ABSTRACT

An electronic device with a variably positionable imaging device comprises a housing having a recessed area for receiving the imaging device therein, the imaging device being disposed within a periphery of the housing when disposed in the recessed area, the imaging device removable from the recessed area and insertable in the recessed area with a lens of the imaging device disposed in each of at least two orientations.

### BACKGROUND

Electronic devices, such as notebook or laptop computers, sometimes comprise embedded imaging devices such as camera devices. For example, some notebook computers comprise camera modules disposed in a display member and positioned adjacent to a display screen so that when a user is utilizing the notebook computer, the camera module is aligned with and/or pointed at the user. However, because the display member is often moved relative to a base member of the notebook computer (e.g., closed to open, open to closed, positioned for tablet use, etc.) delicate and/or fragile components of the camera device are susceptible to being damaged.

### BRIEF DESCRIPTION OF THE DRAWINGS

FIG. 1 is a diagram of a perspective view of an electronic device in which an embodiment of a variably positionable imaging device is employed to advantage;

FIG. 2 is a diagram of the electronic device of FIG. 1 with the imaging device coupled to the electronic device in a use orientation;

FIG. 3 is a diagram of the electronic device of FIG. 1 in a closed position with the imaging device configured in another use orientation;

FIG. 4 is a diagram illustrating the electronic device of FIG. 1 with the imaging device coupled to the electronic device in a stored orientation.

### DETAILED DESCRIPTION OF THE DRAWINGS

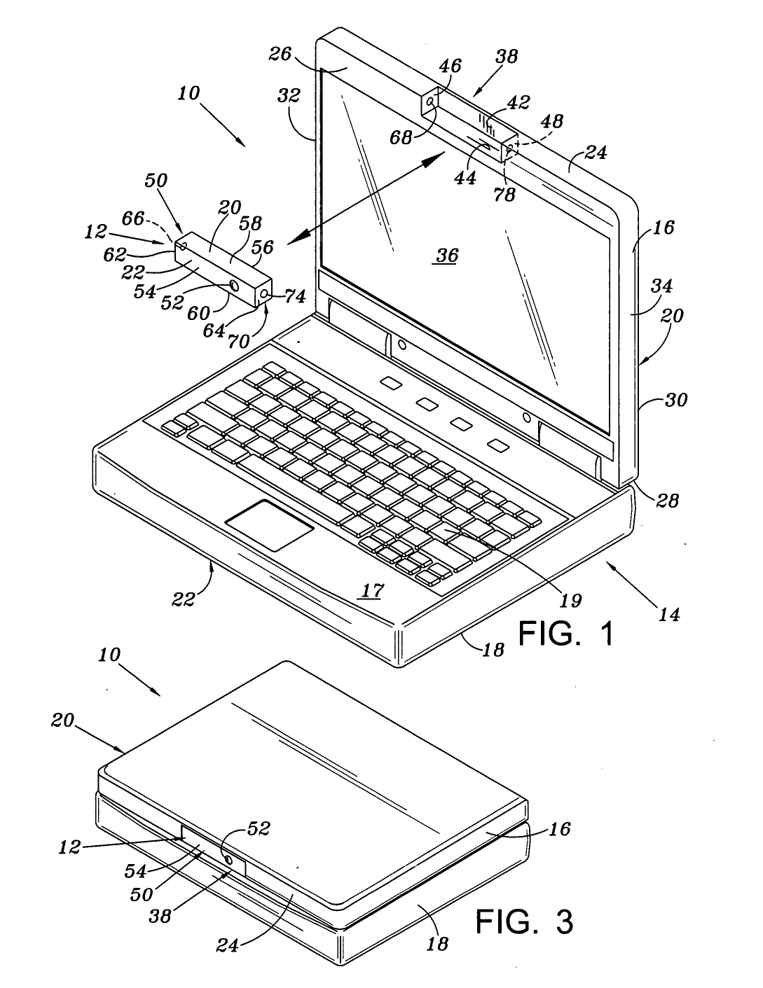

Various embodiments and the advantages thereof are best understood by referring to FIGS. 1-4 like numerals being used for like and corresponding parts of the various drawings.

FIG. 1 is a diagram illustrating a perspective view of an electronic device 10 employing an embodiment of a variably positionable imaging device 12. In the embodiment illustrated in FIG. 1, electronic device 10 comprises a laptop or notebook computer 14; however, it should be understood that electronic device 10 may comprise any type of computing device such as, but not limited to, a tablet personal computer, a personal digital assistant, a desktop computer, a gaming device, or any other type of portable or non-portable electronic device. Imaging device 12 may comprise a camera, an image projection device, or any other type of device for capturing and/or projecting image content. In the embodiment illustrated in FIG. 1, electronic device 10 comprises a display member 16 rotatably coupled to a base member 18. Display member 16 and base member 18 each comprise a housing 20 and 22, respectively, formed having a number of walls. For example, housing 20 supports a display screen 36 and comprises a top wall 24, a front wall/bezel 26, a bottom wall 28, a rear wall 30 and a pair of side walls 32 and 34.

In the embodiment illustrated in FIG. 1, housing 20 comprises a recessed area 38 configured to receive imaging device 12. Imaging device 12 is positionable within recessed area 38 in at least one of a plurality of different use orientations (e.g., imaging device 12 is oriented such that imaging device 12 is usable while disposed within recessed area 38 even though imaging device 12 is not required to be in actual use) or in a stored orientation (e.g., imaging device 12 is oriented such that imaging device 12 is in a stored position and/or otherwise protected from damage when imaging device 12 is disposed within recessed area 38). In the embodiment illustrated in FIG. 1, recessed area 38 is formed by a rear wall 42, a bottom wall 44 and a pair of sidewalls 46 and 48. In FIG. 1, recessed area 38 extends inwardly from front wall 26 and top wall 24; however, it should be understood that recessed area 38 may be otherwise disposed (e.g., extending inwardly from walls 28, 30, 32 and/or 34 or on base member 18).

In the embodiment illustrated in FIG. 1, imaging device 12 comprises a housing 50 configured to receive and/or support various components of imaging device 12 such as, for example, a lens 52. Housing 50 comprises a front surface 54, a rear surface 56, a top surface 58, a bottom surface 60 and a pair of side surfaces 62 and 64. According to some embodiments, imaging device 12 is securely fastened within recessed area 38 by a locking mechanism 70. In the embodiment illustrated in FIG. 1, locking mechanism 70 comprises at least one detent 74 to frictionally engage a corresponding recess 78 disposed within recessed area 38. In the embodiment illustrated in FIG. 1, detent 74 is located on side surface 64 to engage recess 78 located on sidewall 48 of recessed area 38. However, it should be understood that detent 74 may be otherwise located. It should also be understood that locking mechanism 70 may be otherwise configured (e.g., detent 74 disposed within recessed area 38 and corresponding recess 78 disposed on housing 50). Furthermore, it should be understood that different types of locking mechanisms 70 may be utilized (e.g., a retractable and/or actuatable latching mechanism engaging at least a portion of imaging device 12, one or more springs or spring-like structures (at one or both ends of imaging device 12) to provide a biasing retention force and/or even power to imaging device 12).

According to some embodiments, locking mechanism 70 also comprises a connector member 66 for engagement with a corresponding connector member 68 disposed within recessed area 38. Connector members 66 and 68 are configured to facilitate communicative engagement between imaging device 12 and electronic device 10 and secure imaging device 12 in recessed area 38 (by positive engagement between connector members 66 and 68). Preferably, connector members 66 and 68 are configured to facilitate power and signal communications between imaging device 12 and electronic device 10 regardless of the use orientations of imaging device 12 within recess 38. However, it should be understood that connector members 66 and 68 can be otherwise located such that if imaging device 12 is in the stored orientation, no engagement is present thereby facilitating an “off” mode for imaging device 12. Accordingly, locking mechanism 70 securely fastens imaging device 12 to electronic device 10 while also facilitating communicative engagement between imaging device 12 and electronic device 10. It should be understood that other configurations of communicatively coupling imaging device 12 to electronic device 10 may be used such as, for example, configuring locking mechanism 70 on surface 64 with a corresponding connector member 66 disposed on surface 48; providing one or more dedicated connector members 66 on other locations of housing 50 (e.g., on surfaces 56 and/or 60) to communicatively engage corresponding connector members 68 on surfaces 42 and/or 44 of recessed area 38; by infrared and/or wireless methods (facilitating use of imaging device 12 while removed from recessed area 38); etc. Thus, it should be understood that in some embodiments, based on the location connector members 66 and 68 on imaging device 12 and recess 38, imaging device 12 may be powered (or capable of being powered) while in the use and/or stored orientations.

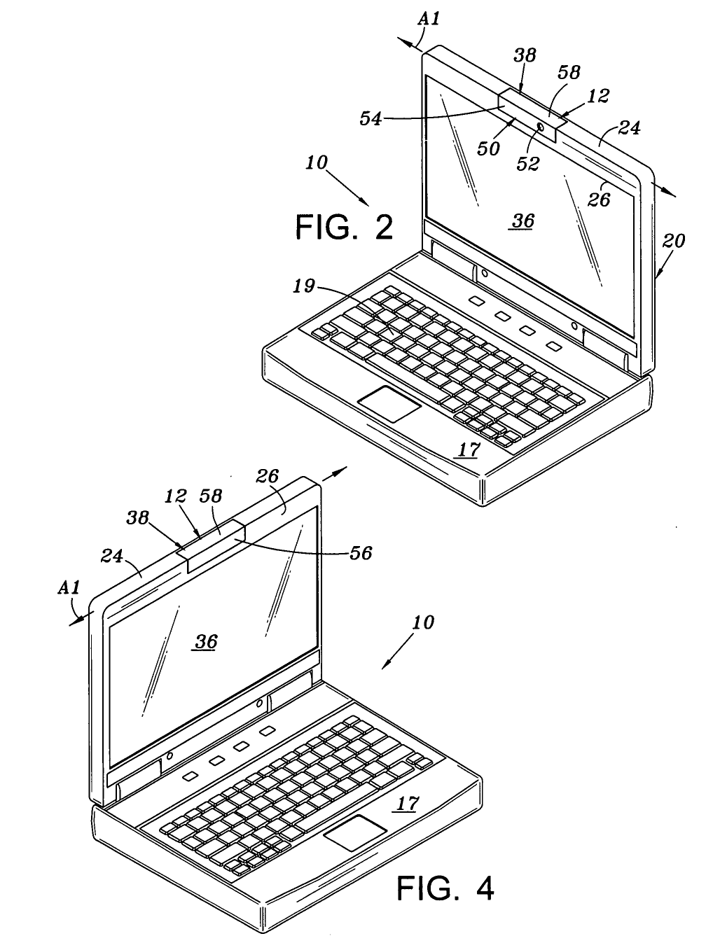

FIG. 2 is a diagram of electronic device 10 of FIG. 1 with imaging device 12 coupled to electronic device 10 in one exemplary use orientation. In FIG. 2, top surface 58 and front surface 54 of housing 50 are flush (flush or substantially flush) with top wall 24 and bezel 26 of housing 20, respectively, and lens 52 is facing outwardly in a direction perpendicular to a viewing surface of display screen 36. In FIG. 2, when imaging device 12 is located within recessed area 38, imaging device 12 is located within a profile or periphery of housing 20 and lens 52 is facing and/or otherwise directed toward a user of electronic device 10.

FIG. 3 is a diagram of electronic device 10 of FIG. 1 in a closed position with imaging device 12 configured in another exemplary use orientation. As used herein, a “closed position” of electronic device 10 shall mean when display member 16 is located in a position substantially parallel and/or coplanar with base member 18 such that display member 16 is disposed in contact with or directly adjacent to a working surface 17 and/or a keyboard 19 of electronic device 10 (FIG. 1) regardless of the direction display screen 36 is facing (e.g., facing toward keyboard 19 or facing away from keyboard 19, such as in a tablet mode of use). In the embodiment illustrated in FIG. 3, front surface 54 of housing 50 is flush (flush or substantially flush) with top wall 24 of housing 20, and lens 52 is facing in a direction perpendicular to top wall 24. Thus, in FIG. 3, when imaging device 12 is located within recessed area 38, imaging device 12 is disposed within a profile or periphery of housing 20 and configured in a use orientation even while display member 16 is in a closed position. For example, in some embodiments, a user may desire to use imaging device 12 while display member 16 is in a closed position relative to base member 18 (e.g., in a tablet mode of operation or in a non-tablet mode of operation), thereby facilitating recording of content by imaging device 12 when electronic device 10 is in a closed position relative to base member 18. However, it should be understood that imaging device 12 may be used in the use orientation illustrated in FIG. 3 while display member is also in an open position relative to base member 18.

FIG. 4 is a diagram illustrating electronic device 10 of FIG. 1 with imaging device 12 coupled to electronic device 10 in a stored orientation. In the embodiment illustrated in FIG. 4, rear surface 56 is flush (flush or substantially flush) with bezel 26 such that lens 52 (FIGS. 2 and 3) is directed inwardly so as to be positioned facing wall 42 (FIG. 1) of recessed area 38 (e.g., wall 54 is oriented so as to be facing wall 42). Furthermore, in the embodiment illustrated in FIG. 4, top surface 58 is flush (flush or substantially flush) with top wall 24 of housing 20. It should be understood that imaging device 12 may be otherwise oriented in the stored position (e.g., rear surface 56 is flush (flush or substantially flush) with top wall 24 such that lens 52 (FIGS. 2 and 3) is directed inwardly so as to be positioned facing wall 44 (FIG. 1). Thus, in FIG. 4, when imaging device 12 is located in the stored orientation, locking mechanism 70 (FIG. 1) securely fastens imaging device 12 within recessed area 38 to prevent inadvertent removal of imaging device 12 from recessed area 38. In the embodiment illustrated in FIG. 4, imaging device 12 is oriented such that surface 62 is adjacent to sidewall 48 to facilitate insertion of connector member 66 inside recessed area 78 (FIG. 1) so as to prevent communications between electronic device 10 and imaging device 12. When imaging device 12 is reoriented in the use orientation, imaging device 12 is configured (e.g., surface 62 is adjacent to surface 48) such that connector member 66 communicatively engages corresponding connector member 68.

According to some embodiments, when transitioning imaging device 12 from a use orientation (FIGS. 2 & 3) to the stored orientation (FIG. 4), imaging device 12 is removed from recessed area 38, reoriented such that lens 52 faces inwardly toward recessed area 38, and then reinserted within recessed area 38 in the stored orientation. Similarly, when transitioning imaging device 12 from the stored orientation (FIG. 4) to a desired use orientation (FIGS. 2 & 3), imaging device 12 is removed from recessed area 38, reoriented such that lens 52 is outwardly directed (e.g., facing away from recessed area 38 in a desired direction), and reinserted within recessed area 38 in the desired use orientation. In FIGS. 1-4, imaging device 12 is configured so as to be rotatably about an axis A1 to facilitate transitioning of imaging device 12 between the use and stored orientations. However, it should be understood that the various positions and orienting direction may be otherwise configured (e.g., flipping or rotating imaging device 12 about an axis perpendicular to axis A1.

In the embodiment illustrated in FIGS. 1-4, housing 50 of imaging device 12 is rectangular in shape; however, it should be understood that housing 50 may be otherwise shaped (e.g., cylindrical). Furthermore, it should be understood that recessed area 38 may be configured to extend through housing 20 (e.g., without rear wall 42). In this configuration, imaging device 12 may be disposed within housing 20 in four different orientations (lens 52 pointed upward from top wall 24, forward from bezel 26, rearward from rear wall 30 and even downward with lens 52 facing bottom wall 44). Further, it should be understood that in some embodiments, imaging device 12 and/or recessed area 38 may be configured such that imaging device 12 extends at least slightly beyond recessed area 38 when disposed in recessed area 38 (e.g., non-flush with top wall and/or bezel 26). In this embodiment, for example, a recessed area or detent may be provided on working surface 17 to receive at least a portion of imaging device 12 therein when display member 18 is in a closed position relative to base member 18.

Thus, embodiments of electronic device 10 and imaging device 12 may be manufactured to facilitate mounting of imaging device 12 in use and stored orientations such that when in a desired use orientation, lens 52 of imaging device 12 is usable and when in the stored orientation, lens 52 of imaging device 12 is disposed within recessed area 38 of housing 20 to protect and/or reduce the likelihood of damage to imaging device 12.

What is claimed is:

1. An electronic device with a variably positionable imaging device, comprising:
a housing having a recessed area for receiving the imaging device therein, the imaging device being disposed within a periphery of the housing when disposed in the recessed area, the imaging device removable from the recessed area and insertable in the recessed area with a lens of the imaging device disposed in each of at least two orientations.

2. The electronic device of claim 1, wherein one of the at least two orientations comprises a use orientation.

3. The electronic device of claim 1, wherein one of the at least two orientations comprises a stored orientation.

4. The electronic device of claim 1, wherein the imaging device is insertable into the recessed area in at least two different use orientations.

5. The electronic device of claim 1, wherein the recessed area extends inwardly from the periphery of the housing.

6. The electronic device of claim 1, wherein the imaging device comprises a housing, the housing of the imaging device disposed flush with the housing of the electronic device when the imaging device is disposed in the recessed area.

7. The electronic device of claim 1, wherein the lens of the imaging device faces into the recessed area when the imaging device is located in a stored orientation.

8. The electronic device of claim 1, further comprising a locking mechanism to secure the imaging device in the at least two orientations.

9. The electronic device of claim 1, wherein the recessed area comprises a connector member for communicative engagement with a corresponding connector of the imaging device.

10. The electronic device of claim 1, wherein the imaging device comprises a camera.

11. A method of manufacturing an electronic device with a variably positionable imaging device, comprising:
providing a housing having a recessed area for receiving the imaging device therein, the imaging device being disposed within a periphery of the housing when disposed in the recessed area, the imaging device removable from the recessed area and insertable in the recessed area with a lens of the imaging device disposed in each of at least two orientations.

12. The method of claim 11, further comprising configuring the housing to facilitate receiving the imaging device in the recessed area in at least one use orientation.

13. The method of claim 11, further comprising configuring the housing to facilitate receiving the imaging device in the recessed area in at least one stored orientation.

14. The method of claim 11, further comprising configuring the housing to facilitate receiving the imaging device in the recessed area in a plurality of different use orientations.

15. The method of claim 11, further comprising forming the recessed area to extend inwardly from the periphery of the housing.

16. The method of claim 11, further comprising providing a housing for the imaging device, the housing of the imaging device disposed flush with the housing of the electronic device when the imaging device is disposed in the recessed area.

17. The method of claim 11, further comprising configuring the imaging device such that the lens of the imaging device faces into the recessed area when the imaging device is located in a stored orientation.

18. The method of claim 1 further comprising providing a locking mechanism to secure the imaging device in the recessed area.

19. The method of claim 11, further comprising providing a connector member in the recessed area for communicative engagement with a corresponding connector of the imaging device.

20. An electronic device with a variably positionable imaging device, comprising:
a housing means, the housing means having a means for receiving the imaging device therein, the imaging device being disposed within a periphery of the housing means when disposed in the receiving means, the imaging device removable from the receiving means and insertable in the receiving means with a lens means of the imaging device means disposed in each of at least two orientations.

21. The electronic device of claim 20, wherein the imaging device is insertable into the receiving means in a plurality of different use orientations.

22. The electronic device of claim 20, wherein the receiving means extends inwardly from a periphery of the housing means.

23. The electronic device of claim 20, wherein the imaging device comprises a housing means, the housing means of the imaging device disposed flush with the housing means of the electronic device when the imaging device is disposed in the receiving means.

24. The electronic device of claim 20, further comprising a means for securing the imaging device in the receiving means.

25. An electronic device with a variably positionable imaging device, comprising:
a first housing rotatably coupled to a second housing having recessed area for receiving the imaging device therein, the imaging device being disposed within a periphery of the second housing when disposed in the recessed area, the imaging device usable while located in the recessed area and while the first housing is in a closed position relative to the second housing.
